(19) United States
(12) Patent Application Publication
(10) Pub. No.: US 2017/0344598 A1
(43) Pub. Date: Nov. 30, 2017

(54) De-Duplication Optimized Platform for Object Grouping

(71) Applicant: International Business Machines Corporation, Armonk, NY (US)

(72) Inventors: M. Corneliu Constantinescu, San Jose, CA (US); Ramani R. Routray, San Jose, CA (US); Kensworth C. Subratie, Sunrise, FL (US)

(73) Assignee: International Business Machines Corporation, Armonk, NY (US)

(21) Appl. No.: 15/166,890

(22) Filed: May 27, 2016

(51) Int. Cl. G06F 17/30

(52) U.S. Cl. CPC G06F 17/30371; G06F 17/30958; G06F 17/30156; G06F 17/30584; G06F 17/30598

(57) ABSTRACT

Embodiments are provided for enhancing storage efficiency in a de-duplication enabled storage system. Using one or more de-duplication metadata repositories local to respective nodes of a storage system, objects are pre-processed in each node. The pre-processing includes deriving a coreness of each object, and grouping the objects into respective cores based on coreness. Each object of a core has at least a minimum coreness. In response to receiving an object request from a target node, the request is iteratively assessed by locating a first core comprising the requested object, calculating a size of the located first core, and identifying a transfer group based on the extracted size. The transfer group is transferred to the target node.

### BACKGROUND OF THE INVENTION

### Technical Field

The embodiments described herein relate to object groupings in data storage. More specifically, the embodiments relate to a platform for object grouping that enhances de-duplication in a clustered environment.

### Description of the Prior Art

Object placement may be a critical decision made in a distributed computing architecture, such as one employing a clustered disk based filesystem. The placement of objects, such as files, blocks, volumes, etc., on disks may be based on filesystem configuration parameters. In one embodiment, the distributed computing architecture employs a shared nothing clustered disk based filesystem, hereinafter referred to as a shared nothing clustered filesystem where each node is independent and self-sufficient. In one embodiment, the nodes in a shared nothing clustered filesystem do not share memory or disk storage. Accordingly, the shared nothing framework eliminates points of contention or failure between the components of the system.

It is understood that objects from different nodes in the shared nothing clustered filesystem may need to be shared, such as when an external system queries information from different nodes simultaneously within the shared nothing clustered filesystem. Sharing of objects may result in duplication of the objects. Data reduction methods, such as de-duplication, may be implemented to save storage space within storage systems. De-duplication, as is known in the art, is a process performed to eliminate redundant data objects, which may also be referred to as chunks, blocks, or extents within a de-duplication enabled storage system. Generally, filesystems assume object-independence in performing tasks, allowing the filesystem to independently manage objects without affecting other objects. At the same time, de-duplication introduces constraints, such as content sharing among objects and externalities. These externalities may include filesystem constraints such as disk capacity and migration cost. In a shared-nothing filesystem, de-duplication introduces additional constraints and challenges to storage management as filesystem tasks may no longer view objects as independent. Accordingly, content sharing is a factor in optimizing object storage efficiency in the filesystem.

### SUMMARY OF THE INVENTION

The aspects described herein include a system, computer program product, and method for enhancing storage efficiency in a de-duplication enable storage system.

According to one aspect, a system is provided to enhance storage efficiency in a de-duplication enabled storage system. The system includes a processing unit in communication with memory. One or more tools are in communication with the processor to, using one or more de-duplication metadata repositories local to respective nodes of a storage system, pre-process objects in each node. The pre-processing includes the tools to derive a coreness of each object, and group the objects into respective cores based on coreness. Each object of a core has at least a minimum coreness. In response to receipt of an object request from a target node, the tools iteratively assess the request by locating a first core comprising the requested object, calculating a size of the located first core, and identifying a transfer group based on the extracted size. The transfer group is transferred to the target node.

According to another aspect, a computer program product is provided to enhance storage efficiency in a de-duplication enable storage system. The computer program product includes a computer-readable storage device having computer-readable program code embodied therewith. The program code is executable by a processor to, using one or more de-duplication metadata repositories local to respective nodes of a storage system, pre-process objects in each node. The pre-processing includes program code to derive a coreness of each object, and group the objects into respective cores based on coreness. Each object of a core has at least a minimum coreness. In response to receipt of an object request from a target node, program code iteratively assesses the request by locating a first core comprising the requested object, calculating a size of the located first core, and identifying a transfer group based on the extracted size. The transfer group is transferred to the target node.

According to yet another aspect, a method is provided for enhancing storage efficiency in a de-duplication enable storage system. Using one or more de-duplication metadata repositories local to respective nodes of a storage system, objects are pre-processed in each node. The pre-processing includes deriving a coreness of each object, and grouping the objects into respective cores based on coreness. Each objects of a core has at least a minimum coreness. In response to receiving an object request from a target node, the request is iteratively assessed by locating a first core comprising the requested object, calculating a size of the located first core, and identifying a transfer group based on the extracted size. The transfer group is transferred to the target node.

Other features and advantages of will become apparent from the following detailed description of the presently preferred embodiments, taken in conjunction with the accompanying drawings.

### BRIEF DESCRIPTION OF THE DRAWINGS

The drawings referenced herein form a part of the specification. Features shown in the drawing are meant as illustrative of only some of the embodiments, and not of all of the embodiments unless otherwise explicitly indicated. Implications to the contrary are otherwise not to be made.

FIG. 1 depicts a block diagram illustrating an exemplary storage system.

FIG. 2 depicts a flowchart illustrating a process for optimizing placement of objects in a filesystem.

FIG. 3 depicts a diagram illustrating an exemplary content sharing graph.

FIG. 4 depicts a block diagram illustrating a system configured to enhance storage efficiency in the storage system of FIG. 1.

FIG. 5 depicts a block diagram illustrating a cloud computing environment.

FIG. 6 depicts a block diagram illustrating a set of functional abstraction model layers provided by the cloud computing environment.

### DETAILED DESCRIPTION

It will be readily understood that the components, as generally described and illustrated in the Figures herein, may be arranged and designed in a wide variety of different configurations. Thus, the following detailed description of the embodiments of the apparatus, system, and method, as presented in the Figures, is not intended to limit the scope of the claims, but is merely representative of select embodiments.

A core is a group of objects, such as files, that share some content. In one embodiment, the core is measured in bytes. The coreness is associated with a set of objects. Namely, coreness is the size of shared content in the core, which in one embodiment is measured in bytes. As such, the core is a group of objects having a minimum coreness, e.g. a minimum number of shared bytes. Since each object in a core can have a different coreness, an extracted coreness is in reference to an object.

The system shown and described herein is labelled with tools to support and enable object de-duplication in a shared nothing clustered filesystem. More specifically, the tools employ object characteristics pertaining to core and coreness with object de-duplication. The tools may be implemented in programmable hardware devices such as field programmable gate arrays, programmable array logic, programmable logic devices, or the like. The tools may also be implemented in software for processing by various types of processors. An identified manager of executable code may, for instance, comprise one or more physical or logical blocks of computer instructions which may, for instance, be organized as an object, procedure, function, or other construct. Nevertheless, the executables of an identified tool need not be physically located together, but may comprise disparate instructions stored in different locations which, when joined logically together, comprise the tool and achieve the stated purpose of the tool.

Indeed, a tool in the form of executable code could be a single instruction, or many instructions, and may even be distributed over several different code segments, among different applications, and across several memory devices. Similarly, operational data may be identified and illustrated herein within the tool, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of different forms of the tool to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

A shared-nothing architecture is a distributed computing architecture in which each node is independent and self-sufficient. More specifically, each node includes one or more processors, main memory and data storage, and communicates with other nodes through an interconnection network. Each node is under the control of its own copy of the operating system and can be viewed as a local site in a distributed database system. The nodes do not share memory or data storage.

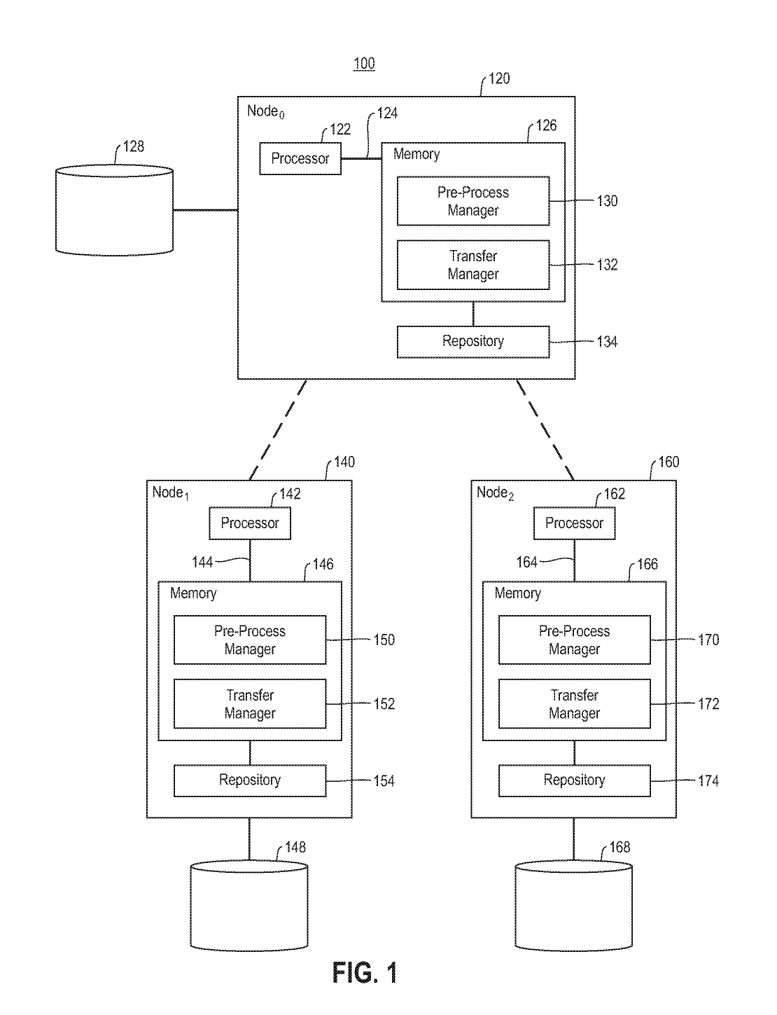

With reference to FIG. 1, a block diagram is provided illustrating an exemplary shared-nothing architecture (100) that also functions as a de-duplication enabled storage system, such as a shared-nothing clustered disk based filesystem. As shown, the system (100) includes three server nodes (120), (140), and (160), also referred to herein as nodes. Each node has at least one processor in communication with memory, and local data storage. As shown, node₀ (120) has a processor (122) in communication with memory (126) across a bus (124), and is further shown with persistent storage (128). Similarly, node₁ (140) has a processor (142) in communication with memory (146) across a bus (144), and is further shown with persistent storage (148), and node₂ (160) has a processor (162) in communication with memory (166) across a bus (164), and is further shown with persistent storage (168). Although each node is shown with local persistent storage, it is understood that data storage may be local or remote, and that each node may have additional data storage components and the storage units shown herein are for illustrative purposes. In one embodiment, one or more of the persistent storage elements shown herein may be remote from the node and accessible across a network connection. Regardless of the location of the persistent storage, it retains the characteristics of persistent storage in a shared-nothing architecture.

Each node in the architecture includes one or more tools to support the de-duplication. As shown herein, each node includes a pre-processing manager and a transfer manager. More specifically, node₀ (120) is shown with pre-processing manager (130) and transfer manager (132), node₁ (140) is shown with pre-processing manager (150) and transfer manager (152), and node₂ (160) is shown with pre-processing manager (170) and transfer manager (172). Each node maintains a repository, e.g. database, with de-duplication metadata. As shown herein, node₀ (120) maintains repository (134), node₁ maintains repository (154), and node₂ maintains repository (174). The repository local to each node retains de-duplication metadata, including but not limited to file chunk sizes, location, and hash values, associated with objects in the associated local data storage. In one embodiment, the pre-processing tool assesses the objects, with the pre-processing chunking the files, creating hash values, and maintaining a file to hash mapping. Based on the pre-processing, objects local to each node are organized into cores with each core having an associated coreness. De-duplication of data may take place local to each node, with a de-duplicated size of a core being the sum of the object sizes in the core where the shared content is only considered once.

In one embodiment, each node may retain a table to organize objects and identify associated cores and object coreness. The following is an example of the table:

TABLE 1

| | | | |
|---|---|---|---|
| Object₀ | Hash₀ | Coreness₀ | Core Assignment |
| Object₁ | Hash₁ | Coreness₁ | Core Assignment |
| Object₂ | Hash₂ | Coreness₂ | Core Assignment |
| Object₃ | Hash₃ | Coreness₃ | Core Assignment |

In a shared-nothing filesystem, the objects of each node are de-duplicated on a node-basis. As shown in this figure, the table is maintained for each node, with the content of the table related to the associated node. More specifically, node₀ (120) is shown with table₀ (136) local to memory (126), node₁ (140) is shown with table₁ (156) local to memory (146), and node₂ (160) is shown with table₂ (176) local to memory (166). In the example shown herein, the table is shown local to memory, although the location of the table with respect to the associated node should not be considered limiting. Accordingly, de-duplication data for each node is created and retained in conjunction with the associated coreness and core assignment.

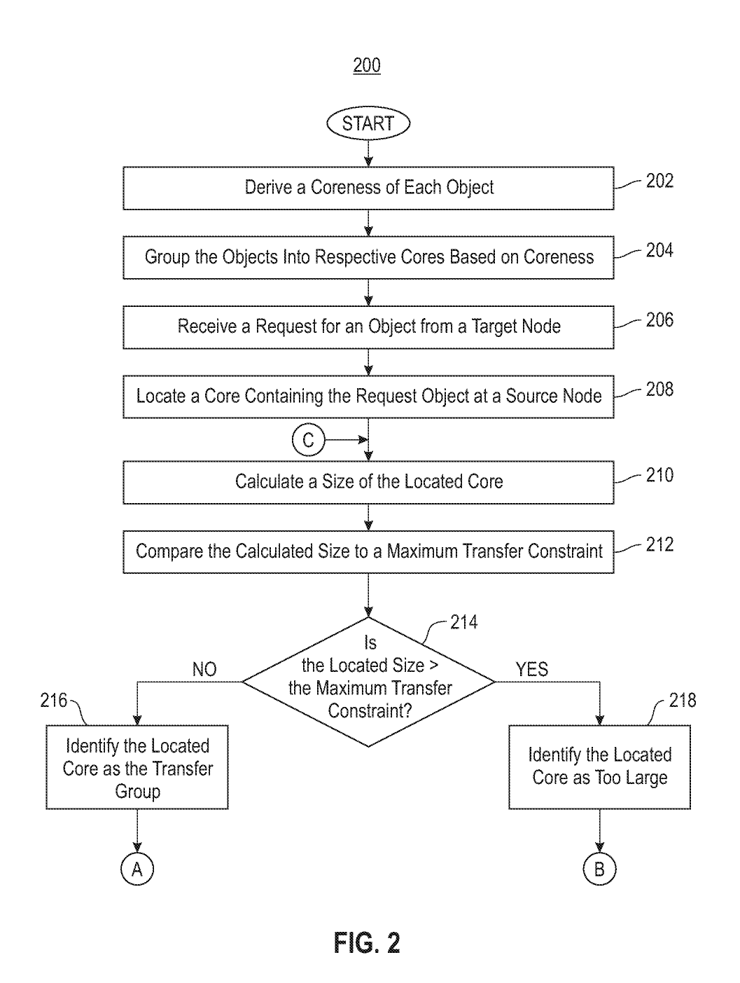

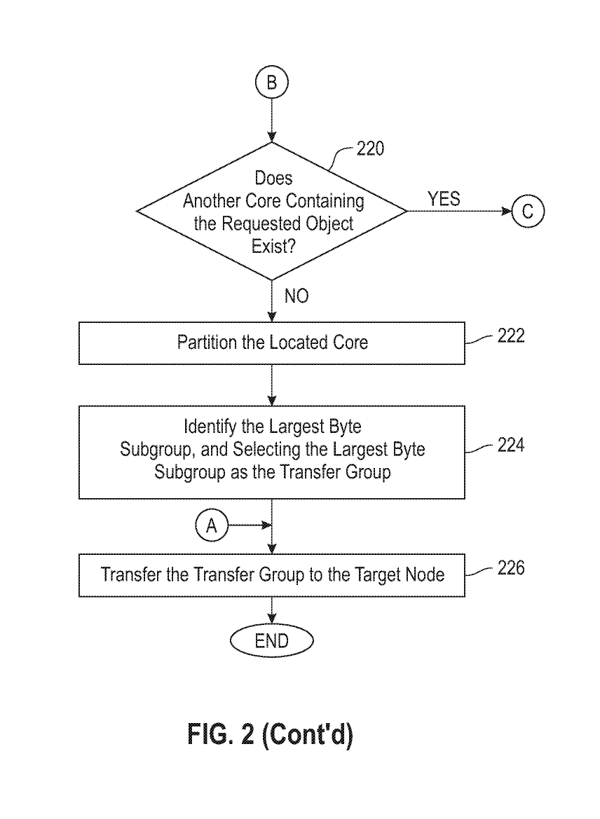

The aspect of deriving core and associated coreness of objects is employed herein and is retained in the repository local to the individual nodes. With reference to FIG. 2, a flowchart (200) is provided illustrating a method for optimizing de-duplication in a shared-nothing clustered filesystem. As shown in FIG. 1, repositories of de-duplication metadata are maintained local to respective nodes of the storage system, objects (e.g., files). The pre-processing includes deriving a coreness of each object (202). At the same time, each pre-processed object has a hash value, which is associated with the object in the respective repository. Objects are grouped into respective cores based on their coreness (204), such that each object of a core has at least a minimum coreness. The pre-processing steps may be performed periodically during an offline scan of the storage system.

In one embodiment, the grouping at step (204) includes building respective content sharing graphs. In one embodiment, content sharing between objects is determined based on metadata by collecting a “trace” by traversing each object. For example, the trace may collect a sequence of content hash values for each object, with each hash associated with a respective object chunk. Accordingly, a comparison of de-duplicated file metadata may be used to identify files that share content.

Each vertex of a content sharing graph corresponds to an object (e.g., a file). Edges of the content sharing graph represent a sharing of content between adjacent vertices. In one embodiment, object identifier data is assigned to each vertex corresponding to its respective object. To minimize the number of edges of the graph, shared content is represented once, and each edge has a weight measure (i.e., coreness) associated with a quantity of total bytes shared between adjacent vertices. In one embodiment, the derivation of the coreness at step (202) includes traversing the content sharing graph with local computation of vertex degrees. The traversal is performed in near linear time based on the number of vertices. Each content sharing graph is designed to be small, scalable, and memory resident. Accordingly, steps (202) and (204) correspond to a pre-processing phase performed in each node in the filesystem to model content sharing between objects.

In one embodiment, each core is a k-core of the content sharing graph. Generally speaking, a k-core of a graph is a maximal connected subgraph in which each vertex is adjacent to at least k other vertices (i.e., each vertex has at least degree k). As applied here, the weight of each edge is used to group the vertices in each k-core. Specifically, a k-core herein represents a maximal connected subgraph of the content sharing graph, such that each vertex shares a total of at least k bytes among its adjacent vertices (i.e., each vertex of a k-core has a minimum coreness value k). Accordingly, each k-core may be viewed as a sub-collection of objects represented by the content sharing graph.

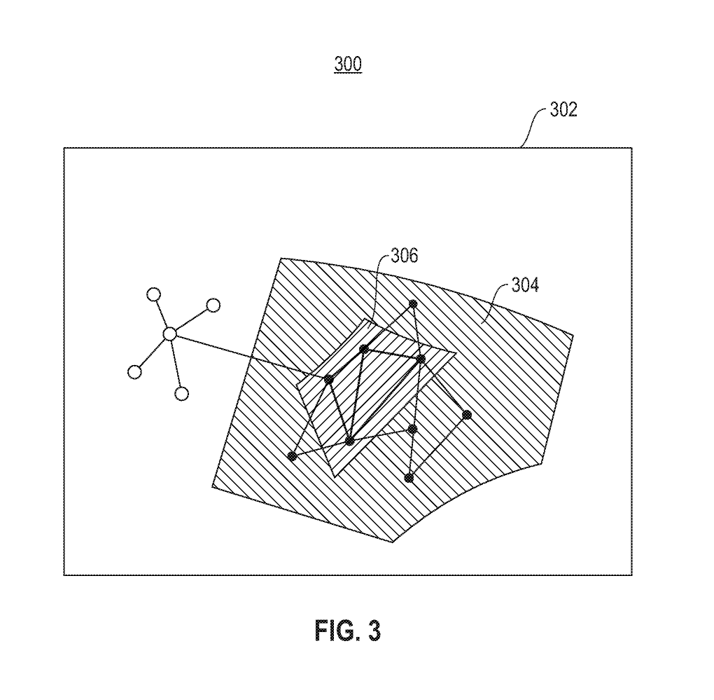

With reference to FIG. 3, an exemplary content sharing graph (300) is provided with an accompanying k-core decomposition. The graph (300) includes a plurality of vertices, with adjacent vertices connected by edges. Each edge indicates a qualitative relationship between the connected vertices. In one embodiment, weight data, or coreness, may be maintained to represent a quantitative data sharing relationship between vertices connected by an edge. For instance, the weight data may indicate a quantity of total bytes shared between the objects represented by the vertices.

In this illustrative example, the graph (300) is decomposed into three k-cores, namely a 1-core (302), a 2-core (304), and a 3-core (306). In this example, each k-core includes vertices having a minimum of k connections. The 1-core (302) is a maximal connected subgraph of graph (300) that includes all the vertices of graph (300) having at least one adjacent vertex, the 2-core (304) is a maximal connected subgraph of graph (300) that includes all vertices having at least two adjacent vertices, and the 3-core (306) is a maximal connected subgraph of graph (300) that includes all the vertices of graph (300) having at least three adjacent vertices. However, as discussed above, a k-core as applied here represents a maximal connected subgraph of a content sharing graph, such that each vertex shares a total of at least k bytes among its adjacent vertices. Typically, due to positioning, vertices nearer to the center of the content sharing graph will have higher coreness values. Generally, higher degree cores are nested subsets of lower degree cores. For instance, as seen in FIG. 3, 3-core (306) is nested within 2-core (304), which is nested in 1-core (302). Accordingly, each vertex will belong to its core, along with any other lower degree cores of the content sharing graph.

The pre-processing steps (202) and (204) are performed to represent the de-duplication domain (i.e., the original set of files in de-duplicated form). Modeling the objects of the filesystem in content sharing graph form may be used to address challenges in storage management associated with de-duplication. For example, the content sharing model may be used to fulfill an object request issued by a node within the shared-nothing filesystem. Referring back to FIG. 2, a request for an object may be received from a target node (206). In one embodiment, the object request is a replication request for the object performed by on-demand synchronization. In on-demand synchronization, the metadata is initially synchronized, but the object data is transferred on demand.

To satisfy the request received at step (206), an appropriate transfer group containing the requested object is selected. To determine the proper selection, a core containing the requested object is located at the source node (208). In one embodiment, step (208) is performed by employing an identifier associated with the requested object, such as an object name. A size of the located core is calculated (210), and the calculated size is compared to a maximum transfer constraint (212). In one embodiment, the size of the located core is a de-duplicated size of the located core, and the maximum transfer constraint is based on an amount of free space on the target node. In one embodiment, the maximum transfer constraint is further based on the coreness of the requested object.

As discussed above, each core, such as the core located at step (208) may be represented as a k-core of a content sharing graph of objects. The de-duplicated size may be calculated at step (210) based on the k-core associated with the content sharing graph. Specifically, the de-duplicated size may be calculated as the sum of the sizes of the vertices minus the sum of the weights of the edges connecting the vertices within the located k-core. Accordingly, the k-core graphical representation provides a relatively non-complex manner to calculate the de-duplicated size of a grouping of objects.

Based on the comparison at step (212), it is determined if the calculated size of the located core exceeds the maximum transfer size constraint (214). The determination at step (214) is used to identify if the located core is a suitable transfer group based on the extracted size. A non-affirmative response to the determination at step (214) indicates that the entire core may be transferred, and thus the located core is identified as the transfer group (216). Accordingly, in the event the extracted size of the located core is less than the maximum transfer constraint, the located care is the transfer group.

An affirmative response to the determination at step (214) is an indication that the size of the located core is identified as too large (218). It is determined if another core containing the requested object exists (220). The purpose of locating another core is to find a core having a smaller de-duplicated size. In one embodiment, the determination includes determining if another core having a higher minimum coreness (i.e., higher degree) exists. For example, if the core located at step (208) is a k-core, it is determined if there exists an l-core such that l>k. Since there is generally an inverse relationship between core degree and quantity of objects in the core, locating another core having a higher minimum coreness than the core located at step (208) will typically yield a smaller grouping of objects. Thus, a positive response to the determination at step (220) is followed by a return to step (210) assess characteristics of the new core in anticipation of formation of a transfer group.

However, if the response to the determination at step (220) is negative, there may be two options available for selection of a transfer group. In one embodiment, the core located at step (208) may be partitioned (222). The effect of partitioning effectively separates the located core into at least two sub-groups. In one embodiment, the sub-groups formed by the partitioning may be the same size, and one of the sub-groups is selected. However, in one embodiment, the sub-groups formed by the partitioning are not the same size. Each sub-group may have an associated size, which in one embodiment is identified by the byte size of the sub-group. The selection process entails identifying the sub-group with the largest size that fits the constraints of the request, and selecting this sub-group of files from the partition as the transfer group (224). Following either of steps (216) or (224), the identified transfer group is transferred to the target node (226).

In an alternative embodiment, a second option to the negative response at step (220) is to identify the requested object as the transfer group for transfer to the target node. Accordingly, organizing objects into cores by shared content allows for efficient selection of an object group for transfer from one node to another in the filesystem in response to a request for an object from a node.

The process of FIG. 2 allows for on-demand replication of groups of objects that share significant content into the same filesystem node, rather than individual objects, by employing source node de-duplication metadata to group data (e.g., to group data into respective content sharing graphs). Rather than transferring the single object as it is requested, synchronization is performed by transferring an appropriately sized object group containing the requested object. This substantially reduces total bandwidth cost, while minimally increasing transfer cost. Accordingly, the embodiments described herein optimize filesystem storage and de-duplication efficiency.

The target node, also referred to herein as the targeted storage node, must support a de-duplicated object group format. If the system already supports de-duplication, the transfer will be formatted to the system's specification so no additional steps will be needed. Otherwise, all the necessary de-duplication metadata required to expand the object group must be created and included in the transfer.

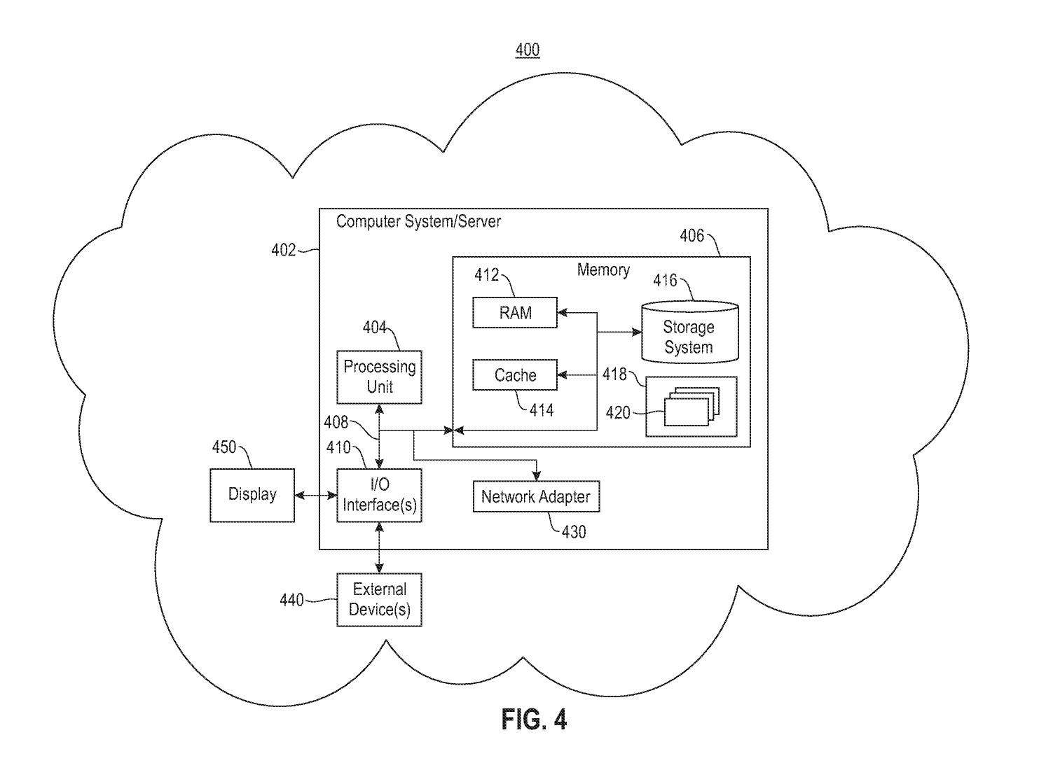

With reference to FIG. 4, a block diagram (400) is provided illustrating an example of a computer system/server (402), hereinafter referred to as a node (402), and configured to optimize storage efficiency in a de-duplication enable storage system in accordance with the embodiments described above. Node (402) is operational with numerous other general purpose or special purpose computing system environments or configurations. Examples of well-known computing systems, environments, and/or configurations that may be suitable for use with node (402) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and filesystems (e.g., distributed storage environments and distributed cloud computing environments) that include any of the above systems or devices, and the like.

Node (402) may be described in the general context of computer system-executable instructions, such as program modules, being executed by a computer system. Generally, program modules may include routines, programs, objects, components, logic, data structures, and so on that perform particular tasks or implement particular abstract data types. Node (402) may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, node (402) is shown in the form of a general-purpose computing device. The components of node (402) may include, but are not limited to, one or more processors or processing units (404), a system memory (406), and a bus (408) that couples various system components including system memory (406) to processor (404). Bus (408) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Node (402) typically includes a variety of computer system readable media. Such media may be any available media that is accessible by node (402) and it includes both volatile and non-volatile media, removable and non-removable media.

Memory (406) can include computer system readable media in the form of volatile memory, such as random access memory (RAM) (412) and/or cache memory (414). Node (402) further includes other removable/non-removable, volatile/non-volatile computer system storage media. By way of example only, storage system (416) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (408) by one or more data media interfaces. As will be further depicted and described below, memory (406) may include at least one program product having a set (e.g., at least one) of program modules that are configured to carry out the functions of the embodiments described above with reference to FIGS. 1-3.

Program/utility (418), having a set (at least one) of program modules (420), may be stored in memory (406) by way of example, and not limitation, as well as an operating system, one or more application programs, other program modules, and program data. Each of the operating systems, one or more application programs, other program modules, and program data or some combination thereof, may include an implementation of a networking environment. Program modules (420) generally carry out the functions and/or methodologies of embodiments as described herein. For example, the set of program modules, or tools (420) may include at least one module or tool that is configured to pre-process objects in each node by using a repository of de-duplication metadata local to the node (402). Specifically, a coreness of each object is derived, and the objects are grouped into respective cores based on coreness, such that each object of a core has at least a minimum coreness. Details with respect to the pre-processing have been described above with reference to FIGS. 1-3.

The tools (420) are further configured to iteratively assess an object request received from a target node (not shown). The iterative assessment includes the tools (420) to locate a first core comprising the requested object, extract a size of the located first core, and identify a transfer group based on the extracted size. The transfer group is then transferred to the target node to satisfy the request. Details with respect to the iterative assessment have been described above with reference to FIGS. 1-3.

Node (402) may also communicate with one or more external devices (440), such as a keyboard, a pointing device, etc.; a display (450); one or more devices that enable a user to interact with node (402); and/or any devices (e.g., network card, modem, etc.) that enable node (402) to communicate with one or more other computing devices. Such communication can occur via Input/Output (I/O) interface(s) (410). Still yet, node (402) can communicate with one or more networks such as a local area network (LAN), a general wide area network (WAN), and/or a public network (e.g., the Internet) via network adapter (430). As depicted, network adapter (430) communicates with the other components of node (402) via bus (408). In one embodiment, a filesystem, such as a distributed storage system, may be in communication with the node (402) via the I/O interface (410) or via the network adapter (430). It should be understood that although not shown, other hardware and/or software components could be used in conjunction with node (402). Examples, include, but are not limited to: microcode, device drivers, redundant processing units, external disk drive arrays, RAID systems, tape drives, and data archival storage systems, etc.

In one embodiment, node (402) is a node of a cloud computing environment. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

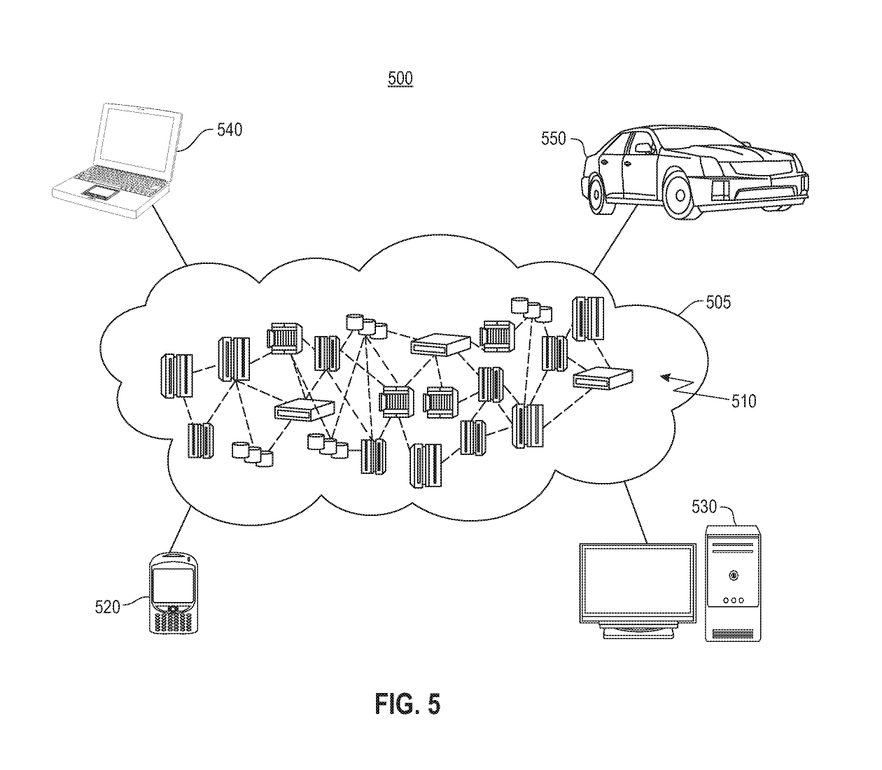

Referring now to FIG. 5, an illustrative cloud computing network (500) is shown. As shown, cloud computing network (500) includes a cloud computing environment (505) having one or more cloud computing nodes (510) with which local computing devices used by cloud consumers may communicate. Examples of these local computing devices include, but are not limited to, personal digital assistant (PDA) or cellular telephone (520), desktop computer (530), laptop computer (540), and/or automobile computer system (350). Individual nodes within nodes (510) may further communicate with one another. They may be grouped (not shown) physically or virtually, in one or more networks, such as Private, Community, Public, or Hybrid clouds as described hereinabove, or a combination thereof. This allows cloud computing environment (500) to offer infrastructure, platforms and/or software as services for which a cloud consumer does not need to maintain resources on a local computing device. It is understood that the types of computing devices (520)-(550) shown in FIG. 5 are intended to be illustrative only and that the cloud computing environment (505) can communicate with any type of computerized device over any type of network and/or network addressable connection (e.g., using a web browser).

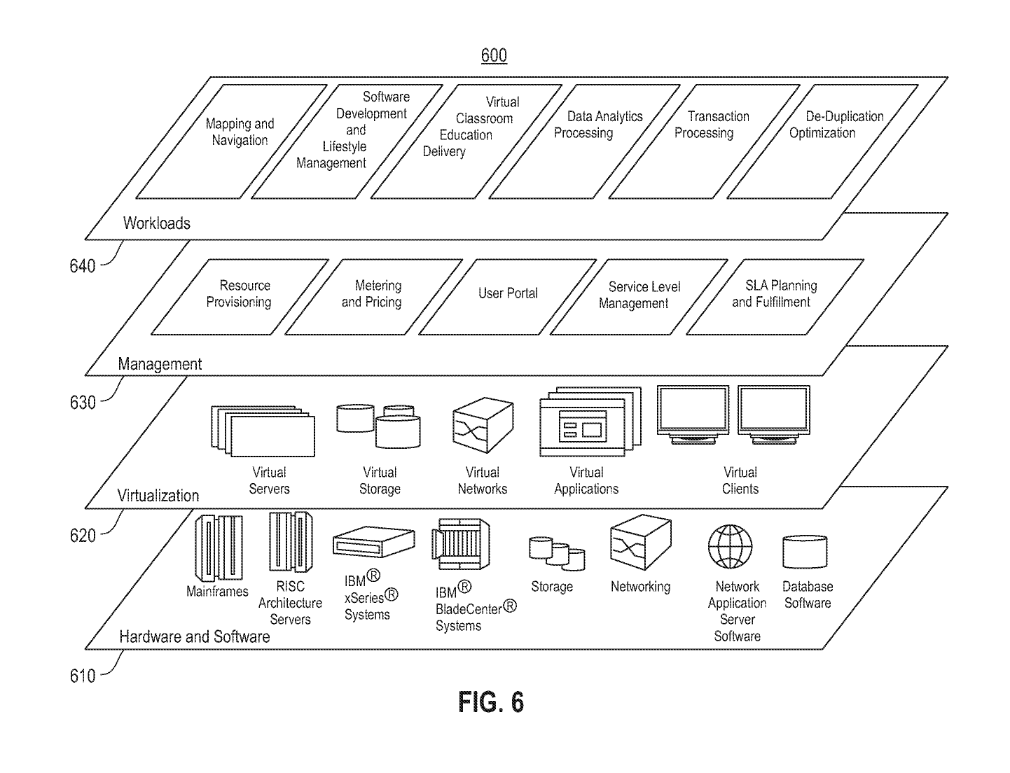

Referring now to FIG. 6, a set of functional abstraction layers provided by cloud computing network (500) is shown. It should be understood in advance that the components, layers, and functions shown in FIG. 6 are intended to be illustrative only, and the embodiments are not limited thereto. As depicted, the following layers and corresponding functions are provided: hardware and software layer (610), virtualization layer (620), management layer (630), and workload layer (640). The hardware and software layer (610) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (620) provides an abstraction layer from which the following examples of virtual entities may be provided: virtual servers; virtual storage; virtual networks, including virtual private networks; virtual applications and operating systems; and virtual clients.

In one example, management layer (630) may provide the following functions: resource provisioning, metering and pricing, user portal, service level management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer (640) provides examples of functionality for which the cloud computing environment may be utilized. Examples of workloads and functions which may be provided from this layer include, but are not limited to: mapping and navigation; software development and lifecycle management; virtual classroom education delivery; data analytics processing; transaction processing; and object storage support within the cloud computing environment.

Embodiments within the scope of the present invention also include articles of manufacture comprising program storage means having encoded therein program code. Such program storage means can be any available media which can be accessed by a general purpose or special purpose computer. By way of example, and not limitation, such program storage means can include RAM, ROM, EEPROM, CD-ROM, or other optical disk storage, magnetic disk storage or other magnetic storage devices, or any other medium which can be used to store the desired program code means and which can be accessed by a general purpose or special purpose computer. Combinations of the above should also be included in the scope of the program storage means.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, random access memory (RAM), read-only memory (ROM), a rigid magnetic disk, and an optical disk. Current examples of optical disks include compact disk read only (CD-ROM), compact disk read/write (CD-R/W) and DVD.

A data processing system suitable for storing and/or executing program code will include at least one processor coupled directly or indirectly to memory elements through a system bus. The memory elements can include local memory employed during actual processing of the program code, bulk storage, and cache memories which provide temporary storage of at least some program code in order to reduce the number of times code must be retrieved from bulk storage during processing.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening networks.

The software implementation can take the form of a computer program product accessible from a computer-useable or computer-readable medium providing program code for use by or in connection with a computer or any instruction processing system.

It will be appreciated that, although specific embodiments have been described herein for purposes of illustration, various modifications may be made without departing from the spirit and scope of the embodiments. Accordingly, the scope of protection of this invention is limited only by the following claims and their equivalents.

We claim:

1. A system comprising:
one or more server nodes, each node comprising processor in communication with memory, and a local repository of de-duplication metadata;
one or more tools in communication with the nodes, the tools to:
using the repositories of de-duplication metadata, pre-process objects in each node, the pre-processing comprising the tools to derive a coreness of each object, and group the objects into respective cores based on coreness, wherein each object of a core has at least a minimum coreness;
in response to receipt of an object request from a target node, iteratively assess the request, the iterative assessment comprising the tools to:
locate a first core comprising the requested object;
calculate a size of the located first core; and
identify a transfer group based on the extracted size; and
transfer the transfer group to the target node.

2. The system of claim 1, wherein the pre-processing further comprises the one or more tools to build at least one content sharing graph, wherein each vertex of the content sharing graph corresponds to an object of the core, wherein the coreness is a weight measure associated with a quantity of total bytes shared between a vertex and its adjacent vertices, and wherein each core is a maximal connected subgraph of the content sharing graph.

3. The system of claim 2, wherein identifying the transfer group comprises the one or more tools to compare the calculated size to a maximum transfer constraint, and wherein the transfer group is identified as the selected group in response to the extracted size being less than the maximum transfer constraint.

4. The system of claim 3, further comprising the one or more tools to, in response to the calculated size exceeding the maximum transfer constraint, partition the located first core, and choose a largest byte sub-group of files from the partition, wherein the transfer group is identified as the largest byte sub-group.

5. The system of claim 3, further comprising the one or more tools to, in response to the calculated size exceeding the maximum transfer constraint, locate a second core containing the requested object, wherein the second core is associated with a higher coreness than the first core.

6. The system of claim 5, wherein the transfer group is identified as the requested object in response to a failure to select the new group.

7. A computer program product comprising a computer-readable storage medium having computer-readable program code embodied therewith, the program code executable by a processor to:
using one or more repositories of de-duplication metadata local to respective nodes of a storage system, pre-process objects in each node, the pre-processing comprising program code to derive a coreness of each object, and group the objects into respective cores based on coreness, wherein each object of a core has at least a minimum coreness;
in response to receipt of an object request from a target node, iteratively assess the request, the iterative assessment comprising program code to:
locate a first core comprising the requested object;
calculate a size of the located first core; and
identify a transfer group based on the extracted size; and
transfer the transfer group to the target node.

8. The computer program product of claim 7, wherein the pre-processing further comprises program code to build at least one content sharing graph, wherein each vertex of the content sharing graph corresponds to an object of the core, wherein the coreness is a weight measure associated with a quantity of total bytes shared between a vertex and its adjacent vertices, and wherein each core is a maximal connected subgraph of the content sharing graph.

9. The computer program product of claim 7, wherein the iterative assessment further comprises program code to compare the calculated size to a maximum transfer constraint, and wherein the transfer group is identified based on the comparison.

10. The computer program product of claim 9, wherein the transfer group is identified as the selected group in response to the calculated size being less than the maximum transfer constraint.

11. The computer program product of claim 9, further comprising program code to, in response to the calculated size exceeding the maximum transfer constraint, partition the located first core, and select a largest byte sub-group of files from the partition, wherein the transfer group is identified as the largest byte sub-group.

12. The computer program product of claim 9, further comprising program code to, in response to the calculated size exceeding the maximum transfer constraint, locate a second core containing the requested object, wherein the second core is associated with a higher coreness than the first core.

13. The computer program product of claim 12, wherein the transfer group is identified as the requested object in response to a failure to locate the second core.

14. A method comprising:
using one or more repositories of de-duplication metadata local to respective nodes of a storage system, pre-processing objects in each node, the pre-processing comprising deriving a coreness of each object, and grouping the objects into respective cores based on coreness, wherein each object of a core has at least a minimum coreness;
in response to receiving an object request from a target node, iteratively assessing the request, the iterative assessment comprising:
selecting a first core comprising the requested object;
calculating a size of the located first core; and
identifying a transfer group based on the extracted size; and
transferring the transfer group to the target node.

15. The method of claim 14, wherein the pre-processing further comprises building at least one content sharing graph, wherein each vertex of the content sharing graph corresponds to an object of the core, wherein the coreness is a weight measure associated with a quantity of total bytes shared between a vertex and its adjacent vertices, and wherein each core is a maximal connected subgraph of the content sharing graph.

16. The method of claim 14, wherein the iterative assessment further comprises comparing the calculated size to a maximum transfer constraint, and wherein the transfer group is identified based on the comparison.

17. The method of claim 16, wherein the transfer group is identified as the selected group in response to the calculated size being less than the maximum transfer constraint.

18. The method of claim 16, further comprising, in response to the calculated size exceeding the maximum transfer constraint, partitioning the located first core, and selecting a largest byte sub-group of files from the partition, wherein the transfer group is identified as the largest byte sub-group.

19. The method of claim 16, further comprising, in response to the calculated size exceeding the maximum transfer constraint, locating a second core containing the requested object, wherein the second core is associated with a higher coreness than the first core.

20. The method of claim 19, wherein the transfer group is identified as the requested object in response to a failure to locate the second core.
